(19) United States
(12) Patent Application Publication
(10) Pub. No.: US 2019/0221099 A1
(43) Pub. Date: Jul. 18, 2019

(54) Snow Sport Tree Well Immersion Alarm

(71) Applicant: TIMOTHY JAMES DURKIN, GAINESVILLE, FL (US)

(72) Inventor: TIMOTHY JAMES DURKIN, GAINESVILLE, FL (US)

(21) Appl. No.: 15/870,986

(22) Filed: Jan. 14, 2018

(51) Int. Cl. G08B 21/04

(52) U.S. Cl. CPC G08B 21/0446; G08B 21/0415; G08B 21/043

(57) ABSTRACT

Tree well falls and snow immersion syndrome represent a danger to snow sport participants, resulting in deaths at ski resorts and other areas. While there is technology available to mitigate risk of avalanche injury, there has been little technology progress to specifically address tree well immersion. Proposed is a wearable alarm system that will detect when the user is inverted and immobile in a tree well, and signal audible (and/or radio, visual, etc) warning to potential rescuers, thus allowing rescue prior to suffocation.

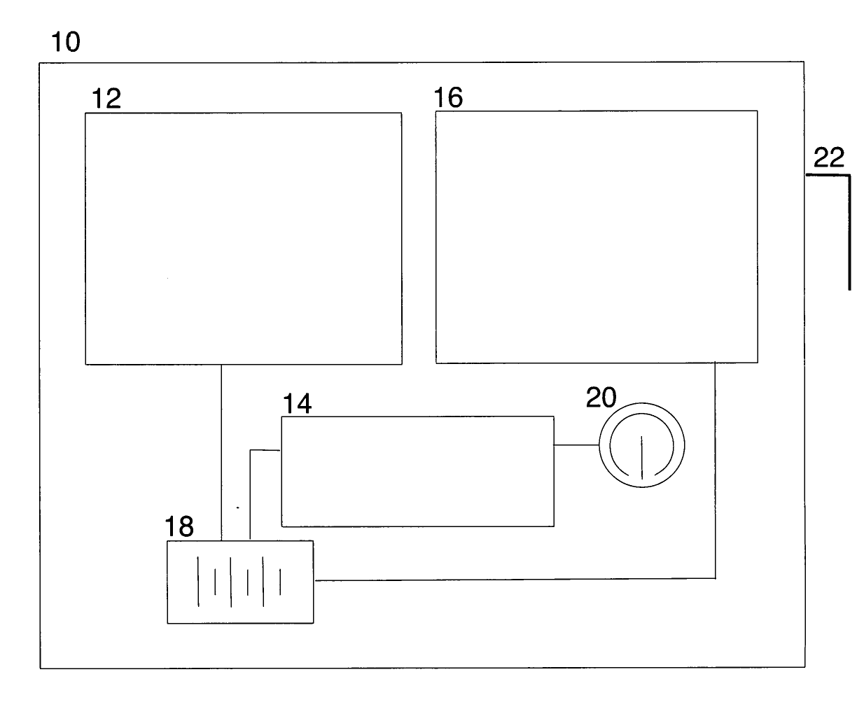

### FIELD OF INVENTION

The present invention is a personal alarm which will alert winter sport partners and other nearby potential rescuers if the user is in a tree well and in need of rescue.

### EXPLANATION OF PROBLEM

Tree wells represent a significant hazard to skiers, snowboarders and other persons in forested areas with deep snowpack. Tree branches can form a void space as the snow pack deepens, creating an unseen hazard into which a person can fall, typically ending up inverted. Most victims are unable to self-extricate. Unless other nearby persons can rapidly assist, death by suffocation or hypothermia is the usual result. 1-10 or more persons are killed in this way annually at US ski resorts alone.

### CURRENT STATE & RELATED PRIOR ART

There is no widely available technology to mitigate the risk of tree well immersion specifically. There are several technologies, primarily designed and marketed for avalanche rescue and survival which are applicable. These include:
avalanche transceiver, probe and snow shovel for the location and extrication of the victim.
RECCO, a proprietary system for victim location, typically used by organized rescue teams.
specially trained search dogs for victim location
AvaLung, a propriety technology to allow breathing while submerged in snow
cellular phone, whistles or two way radio, which require user action to function.

Outside the snowsports industry, fire fighters and others working in dangerous environments are frequently equipped with a PASS (Personal Alert Safety System) device, a wearable alarm which sounds a loud noise when the user stops moving, alerting other nearby persons that the user is likely incapacitated and needing assistance. An example of this type of system can be found in U.S. Pat. No. 5,317,305A. There are also devices that may be applied to an elderly or mobility-challenged patient to alert nearby caregivers if the patient were to fall while attempting to walk or get out of bed. An example of this type of system can be found in U.S. Pat. No. 3,614,763A.

### SUMMARY

A small, durable, alarm that can be attached to clothing, person, backpack or other personal equipment that will signal distress by sound and potential other means when the user is inverted and immobile, such as when in a tree well.

### NUMBERS REFERENCE DRAWING

Portable alarm system attached to user containing a battery (18), sensors (12) for orientation, motion and user input, logic (14) to interpret the sensor input, and audible (16) as well as potentially other means for signaling distress to nearby potential rescuers.

Logic with multiple sensor inputs will prevent false alarm during brief inversion with continued movement, such as during inverted aerial maneuvers during free-style skiing and snowboarding.

Preferred embodiment of the present invention is a small, durable plastic housing (10) that can be attached to the skier, or their clothing or equipment (22). An alternate embodiment is a smart phone application that could accomplish the desired functions using on board hardware, and signal for assistance via cellular or bluetooth networks, in addition to audible noise via speaker.

What is claimed and desired to be secured by patent:

1) a personal alarm capable of manual or automatic activation if the user become immobile and inverted in a tree well.

2) this alarm comprised of sensors to determine orientation and motion, logic to interpret the sensor data and accept user input, peizo-electric noisemaker and/or other means to signal distress, a battery, appropriate case, and means to secure to user or personal equipment.

3) alternatively the alarm could be realized by means of a software application in a “smart” cellular telephone, thereby using the hardware contained within the phone.
